(19) United States
(12) Patent Application Publication
(10) Pub. No.: US 2024/0275787 A1
(43) Pub. Date: Aug. 15, 2024

(54) APPLICATION ACCESS CONTROL METHOD AND APPARATUS, AND COMPUTER DEVICE AND STORAGE MEDIUM

(71) Applicant: Beijing Bytedance Network Technology Co., Ltd., Beijing (CN)

(72) Inventor: Bo HAN, Beijing (CN)

(21) Appl. No.: 18/560,271

(22) PCT Filed: Sep. 27, 2022
(86) PCT No.: PCT/CN2022/121781

§ 371 Date: Nov. 10, 2023

(30) Foreign Application Priority Data
Nov. 5, 2021 (CN) 202111306465.6

(51) Int. Cl. H04L 9/40

(52) U.S. Cl. CPC H04L 63/10; H04L 63/0815; H04L 63/083

(57) ABSTRACT

The disclosure provides a method, an apparatus, a computer device and storage medium for application access control. The method includes: receiving, by an IAM system, a first access request for accessing a target application managed by the IAM system; and rewriting, by the IAM system, the first access request to obtain a second access request comprising proxy domain name information; obtaining, by a proxy server, the second access request, and parsing the proxy domain name information to determine the domain name information of the target application; based on the need for login authentication information, obtaining login account information and obtaining login authentication information input by the user; and sending a login request to an application server corresponding to the target application.

### CROSS REFERENCE

The present application claims priority to Chinese Patent Application No. 202111306465.6, filed on Nov. 5, 2021, and entitled “method, apparatus, computer device and storage medium for application access control”, the entirety of which is incorporated herein by reference.

### FIELD

The present disclosure relates to the field of computer technology, in particular to a method, an apparatus, a computer device and a storage medium for application access control.

### BACKGROUND

With the development of business, many enterprises or units use a large number of information systems to support operations and development of their own business. These information systems have their own account login system. When logging in to each information system, a user needs to enter a login password in the respective information systems for identity authentication. Setting the same login password may cause security risks and setting different login passwords may be difficult to remember.

In response to the above situation, an Identity and Access Management (IAM) system can be used to perform Single Sign On (SSO). The IAM system can call a JavaScript script to submit account and password information obtained from the IAM system to a server corresponding to the information system through a form to achieve automatic login. However, due to security restrictions of browser, some information systems do not support cross-domain submission of forms by the JavaScript script (that is, sending the account and password information obtained from the IAM system to the information system). In this case, automatic login to the information system cannot be achieved.

### SUMMARY

The embodiments of the present disclosure provide at least a method, an apparatus, a computer device and storage medium for application access control.

In the first aspect, the embodiments of the present disclosure provide a method of application access control, including:
receiving, by an Identity and Access Management, IAM, system, a first access request for accessing a target application managed by the IAM system; rewriting, by the IAM system, the first access request to obtain a second access request including proxy domain name information generated based on domain name information of the IAM system and domain name information of the target application;
obtaining, by a proxy server, the second access request generated by the IAM system, and parsing the proxy domain name information of the second access request to determine the domain name information of the target application;
in case of determining that login authentication information is required to log in to the target application, obtaining, by the proxy server from the IAM system, login account information of a user with the target application based on the domain name information of the target application, and obtaining login authentication information input by the user; and
sending, by the proxy server, a login request to an application server corresponding to the target application based on the login account information and the login authentication information.

In an optional implementation, wherein rewriting, by the IAM system, the first access request to obtain a second access request includes:
adding the domain name information of the IAM system into the first access request to obtain the second access request; or
combining, by the IAM system according to a predetermined format, the domain name information of the IAM system with the domain name information of the target application carried in the first access request to obtain the second access request.

In an optional implementation, wherein rewriting, by the IAM system, the first access request to obtain a second access request includes:
rewriting, by the IAM system, the domain name information of the target application carried in the first access request, and encrypting the rewritten proxy domain name information to obtain the second access request carrying the encrypted proxy domain name information; and
the parsing the proxy domain name information of the second access request to determine the domain name information of the target application includes:
decrypting the encrypted proxy domain name information in the second access request to obtain the decrypted proxy domain name information; and
extracting the domain name information of the target application from the decrypted proxy domain name information.

In an optional implementation, wherein the determining that login authentication information is required to log in to the target application includes: determining that the login authentication information is required to log in to the target application based on registration management information stored in the IAM system for the target application; and
the method further includes:
in case of determining that no login authentication information is required to log in to the target application, logging in to the target application by the IAM system to obtain an access credential; wherein the IAM system logs in to the target application based on the login account information in the registration management information;
accessing the target application based on the access credential.

In an optional implementation, wherein the login account information includes a login username and a login password; and
obtaining from the IAM system login account information of a user with the target application includes:
injecting, for a login webpage of the target application, a script for calling a login account; and
executing the script for calling the login account to obtain the login account information from the IAM system and fill in the login webpage with the login account information; the login webpage includes a position region for filling in the login username and login password respectively.

In an optional implementation, wherein sending, by the proxy server, a login request to an application server corresponding to the target application based on the login account information and the login authentication information includes:
in case that the login password filled in the login webpage is a predetermined virtual password, obtaining, from the IAM system, a real password corresponding to the login username based on the domain name information of the target application; and
sending, by the proxy server, the login request to the application server corresponding to the target application based on the real password and the login authentication information.

In an optional implementation, wherein after obtaining, by a proxy server, the second access request generated by the IAM system, and parsing the proxy domain name information of the second access request to determine the domain name information of the target application, the method further includes:
searching for an access credential of the user for the target application from a center server based on the domain name information; and
in case of determining that login authentication information is required to log in to the target application, obtaining, by the proxy server from the IAM system, login account information of a user with the target application based on the domain name information of the target application, and obtaining login authentication information input by the user includes:
in case of no access credential being searched and determining that the login authentication information is required to log in to the target application, obtaining, based on the determined domain name information of the target application, the login account information of the user from the IAM system, and obtaining the login authentication information input by the user.

In an optional implementation, wherein after the searching for an access credential of the user for the target application from a central server, the method further includes:
in case of the access credential being searched, accessing the target application based on the access credential.

In the second aspect, the embodiments of the present disclosure provide an apparatus for application access control, including:
a rewriting module configured to receive, by an Identity and Access Management, IAM, system, a first access request for accessing a target application managed by the IAM system; rewrite, by the IAM system, the first access request to obtain a second access request including proxy domain name information generated based on domain name information of the IAM system and domain name information of the target application;
a first determination module configured to obtain, by a proxy server, the second access request generated by the IAM system, and parse the proxy domain name information of the second access request to determine the domain name information of the target application;
an obtaining module configured to in case of determining that login authentication information is required to log in to the target application, obtain, by the proxy server from the IAM system, login account information of a user with the target application based on the domain name information of the target application, and obtain login authentication information input by the user; and
a sending module configured to send, by the proxy server, a login request to an application server corresponding to the target application based on the login account information and the login authentication information.

In the third aspect, the embodiments of the present disclosure provide a computer device, including: a processor, a memory, and a bus, wherein the memory stores machine readable instructions executable by the processor, when the computer device is operating, the processor communicates with the memory through the bus, and the machine readable instructions, when executed by the processor, performs the first aspect or steps in any possible implementation of the first aspect.

In the fourth aspect, the embodiments of the present disclosure provide a computer readable storage medium having a computer program stored thereon, that, when executed by a processor, performs the first aspect or steps in any possible implementation of the first aspect.

In the fifth aspect, the embodiments of the present disclosure provide a computer program, when executed by a processor, performing the first aspect or steps in any possible implementation of the first aspect.

In the sixth aspect, the embodiments of the present disclosure provide a computer program product, including: a computer program, when executed by a processor, performing the first aspect or steps in any possible implementation of the first aspect.

The method of application access control provided in the embodiments of the present disclosure allows the IAM system to receive the first access request and rewrite the first access request to obtain the second access request including the proxy domain name information, after the user logging in to the IAM system initiates the first access request for the target application managed by the IAM system; then obtain the second access request by the proxy server, and parse the proxy domain name information of the second access request to determine the domain name information of the target application; herein, the proxy domain name information is generated based on the domain name information of the IAM system and the domain name information of the target application, that is, the proxy domain name information is obtained by rewriting the domain name information of the target application to the domain name information of the IAM system.

In order to make the above objectives, features, and advantages of this disclosure more apparent and understandable, the following provides preferred embodiments, and provides a detailed explanation as follows in conjunction with the accompanying drawings.

### BRIEF DESCRIPTION OF THE DRAWINGS

In order to more clearly illustrate technical solutions of the embodiments of the present disclosure, accompanying drawings that need to be used in the embodiments will be briefly introduced below. The drawings here are incorporated into the specification and constitute a part of this specification. These drawings illustrate the technical solutions that conform to the embodiments of the present disclosure and are used together with the specification to illustrate the technical solutions of the present disclosure. It should be understood that the following drawings only illustrate certain embodiments of the present disclosure and should not be regarded as limiting the scope. For those skilled in the art, without creative labor, other related drawings can be obtained based on these drawings.

FIG. 1 illustrates a flowchart of a method of application access control provided in the embodiments of the present disclosure;

FIG. 2 illustrates a flowchart of another method of application access control provided in the embodiments of the present disclosure;

FIG. 3 illustrates a schematic diagram of an apparatus for application access control provided in the embodiments of the present disclosure; and

FIG. 4 illustrates a schematic diagram of a computer device provided in the embodiments of the present disclosure.

### DETAILED DESCRIPTION

In order to make the purpose, technical solutions, and advantages of the embodiments of the present disclosure clearer, the technical solutions in the embodiments of the present disclosure will be described clearly and completely in conjunction with the accompanying drawings below. Apparently, the described embodiments are only part of the embodiments of the present disclosure, not all of them. The components of the embodiments of the present disclosure described and shown in the drawings can be arranged and designed in various configurations. Therefore, the following detailed description of the embodiments of the present disclosure provided in the drawings is not intended to limit the scope of the claimed disclosure, but only represents selected embodiments of the present disclosure. Based on the embodiments of the present disclosure, all other embodiments obtained by those skilled in the art without creative labor belong to the scope of protection of the present disclosure.

With the development of business, many enterprises or units support the operation and development of business by using multiple information systems. Usually, each information system has its own identity authentication system. When users use these information systems, they need to input a login password in each information system for identity authentication. Setting the same login password will have security risks, and setting different login passwords is difficult to remember.

In response to the above situation, the Identity and Access Management (IAM) system may be used to perform single sign-on to achieve unified authentication. Specifically, when a user clicks on an application managed by the IAM system (i.e., information system), the IAM system may provide a browser plug-in. The user installs the browser plug-in on the browser and logs in to his own IAM account. When the user opens the login page of the application, the browser plug-in may automatically obtain an account password information of the application from the IAM system and send it to a server corresponding to the application by submitting a form to achieve automatic login. However, most mobile browsers do not support installing plug-ins.

Alternatively, the IAM system may call a JavaScript script, then call the account and password information of the application and send the account and password information to the application by submitting a form to achieve automatic login. However, due to security restrictions of browser, some applications do not support cross-domain submission of forms by the JavaScript script (that is, sending the account and password information obtained from the IAM system to the application) for automatic login.

The embodiments of the present disclosure provide a method of application access control. After a user logging in to an IAM system initiates a first access request for a target application managed by an IAM system, the IAM system may receive the first access request and rewrite the first access request to obtain a second access request including proxy domain name information. Then, the proxy server obtains the second access request and parses the proxy domain name information in the second access request to determine the domain name information of the target application. Herein, the proxy domain name information is generated based on the domain name information of the IAM system and the domain name information of the target application, that is, the proxy domain name information is obtained by rewriting the domain name information of the target application to the domain name information of the IAM system. In this way, it may overcome the problem that the JavaScript script may not send the login account information obtained from the IAM system to the target application due to cross-domain; further, with the same domain name, the proxy server may obtain the login account information of the user from the IAM system (for example, obtain it from the IAM system by calling the JavaScript script), and then send the login request to the application server corresponding to the target application to achieve automatic login based on the login account information and login authentication information input by the user (e.g., an authentication code).

Defects in the above solutions are results obtained by the inventor after practice and careful study. Therefore, the discovery process of the above problems and the solutions proposed by this disclosure for the above problems in the following text should be the contribution made by the inventor to this disclosure in the process of this disclosure.

It should be noted that similar numbers and letters represent similar items in the following figures, so once an item is defined in one figure, it does not need to be further defined and explained in subsequent figures.

In order to facilitate understanding of the embodiments of the predetermined disclosure, first of all, a method of application access control disclosed in the embodiments of the present disclosure is described in detail. The execution actor of the method of application access control provided in the embodiments of the present disclosure is generally a computer device with certain computing power. The method of application access control provided in the embodiments of the present disclosure may be applied to scenarios where applications installed on personal computers (Personal Computer, PC), Mac (Macintosh), and mobile terminals are accessed, and may be compatible with mainstream computer terminal and mobile terminal browsers.

The method of application access control provided in the embodiments of the present disclosure will be described by taking a proxy server as an example of the execution actor. Herein, the proxy server may be a reverse proxy server.

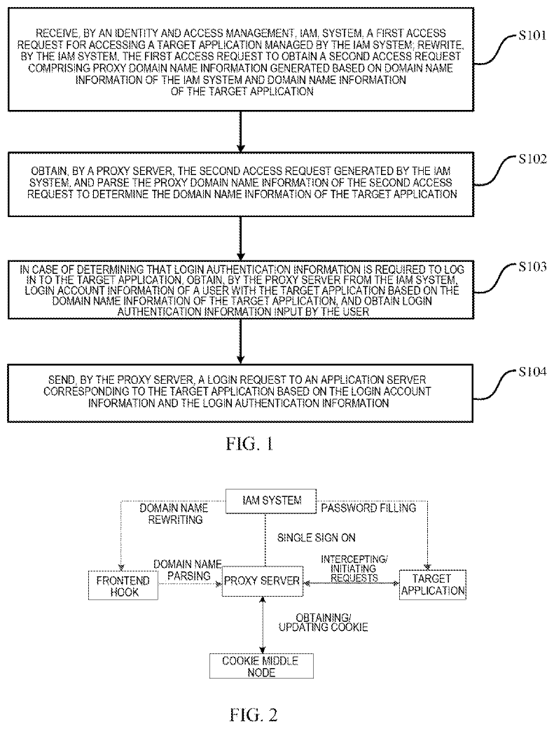

Referring to FIG. 1, which illustrates a flowchart of a method of application access control provided in the embodiments of the present disclosure, the method includes S101 to S104.

S101: receive, by an Identity and Access Management, IAM, system, a first access request for accessing a target application managed by the IAM system; rewrite, by the IAM system, the first access request to obtain a second access request including proxy domain name information generated based on domain name information of the IAM system and domain name information of the target application.

The application managed by the IAM system may be used by the same enterprise or unit. At least one application used by the same enterprise or unit may be added to the IAM system. The IAM system may perform functions such as identity and access management for users who log in to the application managed by the IAM system.

For each application in the IAM system, the IAM system is configured with registration management information input by each user of the application during registration. The registration management information may include login links, login accounts, login passwords, whether the login password is frontend encrypted, and whether the login page has login authentication information (such as authentication codes), etc. The login account information may be the login account, login password, and other information input by the user during registration management information.

In the embodiments of the present disclosure, the user may first log in to the IAM system, and then access the target application managed by the IAM system. Here, the user logs in to the IAM system after triggering a first access request for the target application, the IAM system may receive the first access request, and rewrite domain name information of the target application carried in the first access request to obtain proxy domain name information.

Here, there are many ways to rewrite the domain name information of the target application. The proxy domain name information may be obtained by intercepting the first access request carrying the domain name information of the target application with a predetermined hook script and combining, by the IAM system according to a predetermined format, the domain name information of the IAM system with the domain name information of the target application. It may also be obtained by adding the domain name information of the IAM system into the first access request to obtain the second access request. The second access request may include proxy domain name information generated based on the domain name information of the IAM system and the domain name information of the target application. The domain name information of the IAM system may be located before or after the domain name information of the target application. For example, for website A, assuming that the corresponding domain name information is aaa.com and the domain name information of the IAM system is feilian.cn, then after rewriting the aaa.com, the obtained proxy domain name information may be feilian.cn/proxy/aaa.com or aaa.com.feilian.cn, etc. In one way, the domain name information of the target application may also be placed in the Request Header.

After rewriting the domain name information of the target application carried in the first access request, the second access request carrying proxy domain name information may be obtained, and sends the second access request carrying proxy domain name information.

S102: obtain, by a proxy server, the second access request generated by the IAM system, and parsing the proxy domain name information of the second access request to determine the domain name information of the target application.

In the embodiments of the present disclosure, the obtained proxy domain name information may be encrypted or unencrypted. For the unencrypted proxy domain name information, the domain name information of the target application may be extracted directly from the proxy domain name information. For the encrypted proxy domain name information, the domain name information of the target application may be decrypted first and then extracted. The encrypted proxy domain name information may be obtained by rewriting, by the IAM system, the domain name information of the target application carried in the first access request, and encrypting the rewritten proxy domain name information to obtain the second access request carrying the encrypted proxy domain name information. The proxy domain name information may be obtained by encrypting the rewritten domain name information of the target application with any feasible encryption method (e.g., symmetric encryption method, etc.), where the encryption method may not be particularly limited.

For the encrypted proxy domain name information, when parsing the proxy domain name information of the second access request to determine the domain name information of the target application, may be performed by: first, decrypting the encrypted proxy domain name information in the second access request to obtain the decrypted proxy domain name information; then, extracting the domain name information of the target application from the decrypted proxy domain name information.

Since the decrypted proxy domain name information may include the domain name information of the IAM system and the domain name information of the target application, in this way, the domain name information of the target application may be extracted from the decrypted proxy domain name information.

S103: in case of determining that login authentication information is required to log in to the target application, obtain, by the proxy server from the IAM system, login account information of a user with the target application based on the domain name information of the target application, and obtain login authentication information input by the user.

Here, based on the “whether the login authentication information is on the login page” contained in the registration management information, it is possible to determine whether the login authentication information is requited to log in to the target application. Therefore, based on the registration management information stored in the IAM system for the target application, it is determined that the login authentication information is required to log in to the target application.

After determining the domain name information of the target application, an access credential of the user for the target application may be searched from a center server based on the domain name information. The access credential may be an access credential returned by the application server corresponding to the target application when the user accesses the target application at historical time. Here, the access credential may be a cookie. The center server, which is a cookie middle node, may be a dedicated backend server or a frontend local storage, such as Local Storage. The center server may be used to store the above access credential. By storing the access credential in the center server instead of the target application, the access credential may be prevented from being exposed to the user browser, improving security, and avoiding login exceptions caused by duplicate cookie names.

If no access credentials of the user for the target application are found from the center server, it indicates that the user has not visited the target application.

Thus, in one embodiment, in case of no access credential being searched and determining that the login authentication information is required to log in to the target application, based on the determined domain name information of the target application, the login account information of the user from the IAM system may be obtained, and the login authentication information input by the user may be obtained.

According to the foregoing, the IAM system is configured with registration management information of each user of the target application, the registration management information includes login account information, and therefore, here based on the domain name information, the login account information of the user logging in to the IAM system may be obtained from the IAM system.

The login authentication information may be input by the user on the login webpage and may be a public automatic program used to distinguish whether the user is a computer or a human. The login authentication information may be any form of authentication information, such as verification codes in alphabetical or numeric form, and is not specifically limited here.

A prerequisite for The IAM system to provide feedback on the login account information is to determine that the access domain name information of the target application corresponds to the proxy domain name information rewritten by the IAM system.

In the process of obtaining the login account information of the user from the IAM system, for a login webpage of the target application, a script for calling a login account may be injected. When executing the script for calling the login account, the login account information may be obtained from the IAM system and may be filled in the login webpage with the login account information. As mentioned earlier, the proxy domain name information is domain name information rewritten the domain name information of the target application to the domain name information of the IAM system. Therefore, under the prerequisite for the IAM system determining that the access domain name information of the target application corresponds to the proxy domain name information rewritten by the IAM system, that is, under the prerequisite of the same domain name, a script for calling a login account may obtain the login account information of the user from the IAM system. Herein, the script for calling a login account may be a JavaScript script. After obtaining the login account information, the script for calling a login account may fill in the login webpage with the login account information. The login account information includes the login username and login password. The login webpage contains a position region for filling in the login username and login password respectively. The login webpage with the login account information may fill in the corresponding position on the login webpage with the login username and login password.

S104: send, by the proxy server, a login request to an application server corresponding to the target application based on the login account information and the login authentication information.

Here, in order to prevent the user account from being maliciously attacked, causing the login account information filled in the login webpage to leak, the login password filled in the login webpage may be a predetermined non-real password configured by IAM.

In one embodiment, in case that the login password filled in the login webpage is a predetermined virtual password, from the IAM system, a real password corresponding to the login username may be obtained based on the domain name information of the target application; and by the proxy server, the login request may be sent to the application server corresponding to the target application based on the real password and the login authentication information.

That is, the login password filled in the login webpage may not be a plaintext password, which may to some extent prevent intermediaries who maliciously attack user accounts from logging in to the target application based on the login password in the login webpage. At the same time, based on the domain name information of the target application, the real password corresponding to the login username may be obtained from the IAM system, and the login request may be sent to the application server corresponding to the target application based on the real password and login authentication information. In this way, the security of login account information may be ensured while achieving automatic login.

If the access credential of the user for the target application may be found from the center server, it indicates that the user has successfully accessed the target application. Therefore, in case of the access credential being found, the proxy server may directly access the target application based on the access credential.

The above process describes the process that the proxy server may, in the case of the access credential being searched, be directly access the target application based on the access credential, and may, in the case of no access credential being searched and the login authentication information being required to log in, achieve automatic login to the target application.

The following will be described the process that in the case of the no access credential being searched and the login authentication information being not required to log in, automatic login to the target application may be achieved.

In the case of no access credential being searched and the login authentication information being not required to log in, the following steps may be performed: in case of determining that no login authentication information is required to log in to the target application, logging in to the target application by the IAM system to obtain an access credential; wherein the IAM system logs in to the target application based on the login account information in the registration management information; accessing the target application based on the access credential.

Here, by calling the IAM system, the IAM system may automatically log in to the target application based on the login account information corresponding to the target application, so that an application browser corresponding to the target application may return the access credential. The IAM system returns the obtained access credential to the proxy server. Based on the access credential, the proxy server updates the access credential at the center server. Finally, based on the access credential, the target application is accessed.

The following steps of another method of application access control are provided in the embodiments of the present disclosure, as shown in FIG. 2. Before the method of application access control provided in embodiments of the present disclosure is performed, an administrator may add a target application to the IAM system and configure a registration management information of the target application. The registration management information may include login links, login accounts, login passwords, whether the login password is frontend encrypted, and whether the login page has login authentication information (such as authentication codes), etc. The login account information may be the login account, login password, and other information input by the user during registration management information.

When the user logs in to the IAM system and clicks on the target application in the IAM system to access, the first access request carrying the domain name information of the target application may be obtained by a predetermined hook script, the domain name information in the first access request is rewritten, and the domain name information of the target application is rewritten to the domain name of the IAM system. The obtained proxy domain name information may contain the domain name information of the target application and the domain name information of the IAM system.

After the domain name information of the target application is rewritten, the obtained proxy domain name information is encrypted with the encryption method to obtain the encrypted proxy domain name information.

After the proxy server intercepts the second access request carrying the proxy domain name information, first, the proxy domain name information of the second access request is decrypted, and the domain name information in the proxy domain name information is extracted, i.e., the real domain name information corresponding to the target application.

Then, the proxy server queries the access credential cookie related to the domain name information from the cookie middle node. If there is a cookie related to the domain name information, the proxy server accesses the target application based on the cookie. If there is no cookie related to the domain name information, it indicates that the user accesses the target application for the first time. At this time, the proxy server may call the IAM system.

Whether the login page contained in the registration management information configured by the proxy server in the IAM system has authentication code information to determine whether it may log in directly.

Specifically, if there is no authentication code on the login page, it indicates that it may log in directly. At this time, the IAM system may call the login interface of the target application and obtain the cookie. That is, the IAM system may log in to the target application based on the login username and password contained in the login account information, and then receive the cookie returned by the application server corresponding to the target application. The IAM system may return the cookie to the proxy server, which updates the cookie at the cookie middle node and accesses the target application based on the cookie.

In case of determining that there is an authentication code the login page, it indicates that direct login is not allowed. The proxy server may inject the JavaScript script into the login webpage of the target application. When executing the JavaScript script, the JavaScript script may obtain the login account information from the IAM system, and fill in the login form with the login username and login password in the login account information. Then, the proxy server obtains the authentication code input by the user in the login webpage and generates a login request based on the login username, login password, and obtained authentication code in the login form, and sends the login request to the application server of the target application.

In case that the login password filled in the login webpage is a predetermined virtual password, the proxy server may obtain, from the IAM system, a real password corresponding to the login username based on the domain name information of the target application with the predetermined hook script; then, send the login request to the application server corresponding to the target application based on the real password and the login authentication information. After receiving the cookie returned by the application server for the target application, the proxy server may update the cookie in the cookie middle node so that the target application may be accessed directly based on the cookie in the cookie middle node next time.

Those skilled in the art will appreciate, in the above methods of the detailed description, the writing order of each step does not mean a strict execution order and constitute any limitation on the implementation process, the specific execution order of each step should be determined by its function and possible internal logic.

Based on the same inventive concept, the embodiments of the present disclosure also provide an apparatus for application access control corresponding to the method of application access control, since the principle of the apparatus solving the problem in the embodiments of the present disclosure is similar to the method of application access control in the above-described embodiments of the present disclosure, the embodiments of the apparatus may be referred to the embodiments of the method, and any repetition will not be repeated.

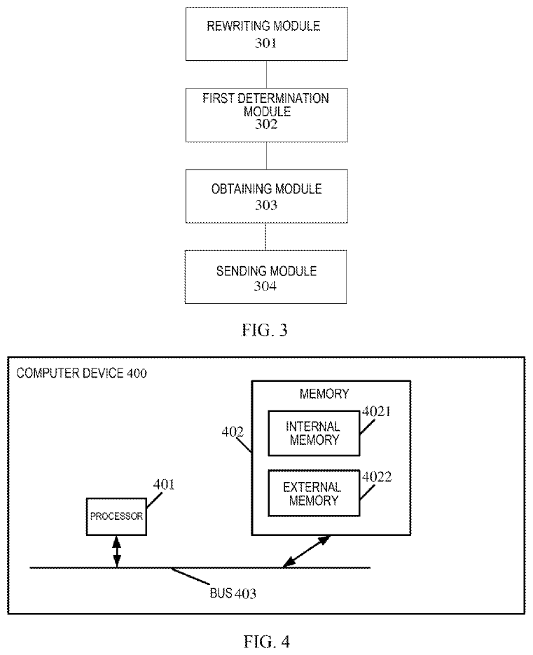

Referring to FIG. 3, the embodiments of the present disclosure provide a schematic diagram of an architecture of an apparatus for application access control. The apparatus including: a rewriting module 301, a first determination module 302, an obtaining module 303, and a sending module 304; wherein,
the rewriting module 301 configured to receive, by an Identity and Access Management, IAM, system, a first access request for accessing a target application managed by the IAM system; rewrite, by the IAM system, the first access request to obtain a second access request including proxy domain name information generated based on domain name information of the IAM system and domain name information of the target application;
the first determination module 302 configured to obtain, by a proxy server, the second access request generated by the IAM system, and parse the proxy domain name information of the second access request to determine the domain name information of the target application;
the obtaining module 303 configured to in case of determining that login authentication information is required to log in to the target application, obtain, by the proxy server from the IAM system, login account information of a user with the target application based on the domain name information of the target application, and obtain login authentication information input by the user;
the sending module 304 configured to send, by the proxy server, a login request to an application server corresponding to the target application based on the login account information and the login authentication information.

In an optional implementation, the rewriting module 301 specifically is configured for: adding the domain name information of the IAM system into the first access request to obtain the second access request; or
combining, by the IAM system according to a predetermined format, the domain name information of the IAM system with the domain name information of the target application carried in the first access request to obtain the second access request.

In an optional implementation, the rewriting module 301 is specifically configured for:
rewriting, by the IAM system, the domain name information of the target application carried in the first access request, and encrypting the rewritten proxy domain name information to obtain the second access request carrying the encrypted proxy domain name information; and
the first determination module 302 is specifically configured for:
decrypting the encrypted proxy domain name information in the second access request to obtain the decrypted proxy domain name information; and
extracting the domain name information of the target application from the decrypted proxy domain name information.

In an optional implementation, the first determining module 302 is specifically configured for: determining that the login authentication information is required to log in to the target application based on registration management information stored in the IAM system for the target application; and
the apparatus also includes:
a login module configured for in case of determining that no login authentication information is required to log in to the target application, logging in to the target application by the IAM system to obtain an access credential; wherein the IAM system logs in to the target application based on the login account information in the registration management information; and
a first accessing module configured for accessing the target application based on the access credential.

In an optional implementation, the login account information includes a login username and a login password; and
the obtaining module 303 is specifically configured for:
injecting, for a login webpage of the target application, a script for calling a login account; and
executing the script for calling the login account to obtain the login account information from the IAM system and fill in the login webpage with the login account information; the login webpage comprises a position region for filling in the login username and login password respectively.

In an optional implementation, the sending module 304 is specifically configured for:
in case that the login password filled in the login webpage is a predetermined virtual password, obtaining, from the IAM system, a real password corresponding to the login username based on the domain name information of the target application; and
sending, by the proxy server, the login request to the application server corresponding to the target application based on the real password and the login authentication information.

In an optional implementation, the apparatus further includes:
a searching module configured for searching for an access credential of the user for the target application from a center server based on the domain name information; and
the obtaining module 303 is specifically configured for:
in case of no access credential being searched and determining that the login authentication information is required to log in to the target application, obtaining, based on the determined domain name information of the target application, the login account information of the user from the IAM system, and obtaining the login authentication information input by the user.

In an optional implementation, the apparatus further includes:
a second accessing module configured for in case of the access credential being searched, accessing the target application based on the access credential.

Description of the processing flow of each module in the apparatus, and the interaction flow between the modules may refer to the relevant description of the above method embodiments, not described in detail here.

Based on the same technical concept, the embodiments of the present disclosure also provide a computer device. Referring to FIG. 4, a structural schematic diagram of the computer device 400 provided in the embodiments of the present disclosure includes a processor 401, a memory 402, and a bus 403. The memory 402 is configured to store execution instructions, including internal memory 4021 and external memory 4022. Here, the internal memory 4021, also known as internal memory, is configured to temporarily store arithmetic data in the processor 401 and data exchanged with external memory 4022 such as a hard disk. The processor 401 exchanges data with the external memory 4022 through the internal memory 4021. When the computer device 400 is running, the processor 401 communicates with the memory 402 through the bus 403, causing the processor 401 to execute the following instructions:
receiving, by an Identity and Access Management, IAM, system, a first access request for accessing a target application managed by the IAM system; rewriting, by the IAM system, the first access request to obtain a second access request comprising proxy domain name information generated based on domain name information of the IAM system and domain name information of the target application;
obtaining, by a proxy server, the second access request generated by the IAM system, and parsing the proxy domain name information of the second access request to determine the domain name information of the target application;
in case of determining that login authentication information is required to log in to the target application, obtaining, by the proxy server from the IAM system, login account information of a user with the target application based on the domain name information of the target application, and obtaining login authentication information input by the user; and
sending, by the proxy server, a login request to an application server corresponding to the target application based on the login account information and the login authentication information.

The embodiments of the present disclosure further provide a computer readable storage medium having a computer program stored thereon, that, when executed by a processor, performs steps of the method of application access control described in the above embodiments. Herein, the storage medium may be a volatile or non-volatile computer readable storage medium.

The embodiments of the present disclosure further provide a computer program, the computer program including program code, the program code including instructions may be used to perform the steps of the method of application access control described in the above embodiments. The above-described method embodiments may be referred for details and will not be described herein again.

The embodiments of the present disclosure further provide a computer program product, the computer product carries program code, and the program code including instructions may be used to perform the steps of the method of application access control described in the above embodiments. The above-described method embodiments may be referred for details and will not be described herein again.

Herein, the computer program product described above may be implemented in hardware, software, or a combination thereof. In an optional embodiment, the computer program product is implemented as a computer storage medium, and in another optional embodiment, the computer program product is implemented as a software product, such as a Software Development Kit (SDK) and the like.

Those skilled in the art may clearly understand that for the convenience and brevity of description, the specific working process of the system and apparatus described above may refer to the corresponding process in the aforementioned method embodiments, which will not be repeated here. In several embodiments provided in this disclosure, it should be understood that the disclosed system, apparatus, and method may be implemented in other ways. The apparatus embodiments described above are only illustrative. For example, the division of the unit is only a logical function division, and there may be other division methods in actual implementation. For another example, a plurality of units or components may be combined or integrated into another system, or some features may be ignored or not executed. Another point is that the coupling or direct coupling or communication connection between the displayed or discussed apparatuses or units may be indirectly coupled or connected through some communication interfaces, apparatuses, or units, which may be electrical, mechanical, or other forms.

The units described as separate components may or may not be physically separated, and the components displayed as units may or may not be physical units, that is, they may be located in one place or may be distributed to a plurality of network units. Some or all of the units may be selected according to actual needs to achieve the purpose of the embodiments of the present disclosure.

Further, the functional units in various embodiments of the present disclosure may be integrated in one processing unit, each unit may be physically present alone, may be two or more units integrated in one unit.

If the function is implemented in the form of a software functional unit and sold or used as an independent product, it may be stored in a non-volatile computer-readable storage medium executable by a processor. Based on this understanding, the technical solution of the present disclosure may be embodied in the form of a software product, which is stored in a storage medium and includes several instructions to make a computer device (which may be a personal computer, a server, or a network device, etc.) perform all or part of the steps of the methods described in each embodiment of the present disclosure. The aforementioned storage medium include: U disk, mobile hard disk, Read-Only Memory (ROM), Random Access Memory (RAM), magnetic disk or optical disk, and other medium that may store program code.

Finally, it should be noted that: the above embodiments are only a detailed implementation of the present disclosure, to illustrate the technical solution of the present disclosure, rather than limiting it, the scope of protection of the present disclosure is not limited thereto, although with reference to the foregoing embodiments of the present disclosure has been described in detail, those skilled in the art should understand that: any person skilled in the art in the field within the technical scope of the present disclosure may still modify or easily think of changes to the technical solutions described in the foregoing embodiments, or equivalently replace some of the technical features; and these modifications, changes or substitutions, does not make the essence of the corresponding technical solutions from the spirit and scope of embodiments of the present disclosure, and should be covered within the scope of the present disclosure. Therefore, the scope of the present disclosure should be subject to the scope of the claims.

1. A method of application access control, comprising:
receiving, by an Identity and Access Management, IAM, system, a first access request for accessing a target application managed by the IAM system;
rewriting, by the IAM system, the first access request to obtain a second access request comprising proxy domain name information generated based on domain name information of the IAM system and domain name information of the target application;
obtaining, by a proxy server, the second access request generated by the IAM system, and parsing the proxy domain name information of the second access request to determine the domain name information of the target application;
in case of determining that login authentication information is required to log in to the target application, obtaining, by the proxy server from the IAM system, login account information of a user with the target application based on the domain name information of the target application, and obtaining login authentication information input by the user; and
sending, by the proxy server, a login request to an application server corresponding to the target application based on the login account information and the login authentication information.

2. The method of claim 1, wherein rewriting, by the IAM system, the first access request to obtain a second access request comprises:
adding the domain name information of the IAM system into the first access request to obtain the second access request; or
combining, by the IAM system according to a predetermined format, the domain name information of the IAM system with the domain name information of the target application carried in the first access request to obtain the second access request.

3. The method of claim 1, wherein rewriting, by the IAM system, the first access request to obtain a second access request comprises:
rewriting, by the IAM system, the domain name information of the target application carried in the first access request, and encrypting the rewritten proxy domain name information to obtain the second access request carrying the encrypted proxy domain name information; and
the parsing the proxy domain name information of the second access request to determine the domain name information of the target application comprises:
decrypting the encrypted proxy domain name information in the second access request to obtain the decrypted proxy domain name information; and
extracting the domain name information of the target application from the decrypted proxy domain name information.

4. The method of claim 1, wherein the determining that login authentication information is required to log in to the target application comprises: determining that the login authentication information is required to log in to the target application based on registration management information stored in the IAM system for the target application; and
the method further comprises:
in case of determining that no login authentication information is required to log in to the target application, logging in to the target application by the IAM system to obtain an access credential; wherein the IAM system logs in to the target application based on the login account information in the registration management information;
accessing the target application based on the access credential.

5. The method of claim 1, wherein the login account information comprises a login username and a login password; and
obtaining from the IAM system login account information of a user with the target application comprises:
injecting, for a login webpage of the target application, a script for calling a login account; and
executing the script for calling the login account to obtain the login account information from the IAM system and fill in the login webpage with the login account information; the login webpage comprises a position region for filling in the login username and login password respectively.

6. The method of claim 5, wherein sending, by the proxy server, a login request to an application server corresponding to the target application based on the login account information and the login authentication information comprises:
in case that the login password filled in the login webpage is a predetermined virtual password, obtaining, from the IAM system, a real password corresponding to the login username based on the domain name information of the target application; and
sending, by the proxy server, the login request to the application server corresponding to the target application based on the real password and the login authentication information.

7. The method of claim 1, wherein after obtaining, by a proxy server, the second access request generated by the IAM system, and parsing the proxy domain name information of the second access request to determine the domain name information of the target application, the method further comprises:
searching for an access credential of the user for the target application from a center server based on the domain name information; and
in case of determining that login authentication information is required to log in to the target application, obtaining, by the proxy server from the IAM system, login account information of a user with the target application based on the domain name information of the target application, and obtaining login authentication information input by the user comprises:
in case of no access credential being searched and determining that the login authentication information is required to log in to the target application, obtaining, based on the determined domain name information of the target application, the login account information of the user from the IAM system, and obtaining the login authentication information input by the user.

8. The method of claim 7, wherein after the searching for an access credential of the user for the target application from a central server, the method further comprises:
in case of the access credential being searched, accessing the target application based on the access credential.

9-13. (canceled)

14. A computer device, comprising: a processor, a memory, and a bus, wherein the memory stores machine readable instructions executable by the processor, when the computer device is operating, the processor communicates with the memory through the bus, and the machine readable instructions, when executed by the processor, performs acts comprising:
receiving, by an Identity and Access Management, IAM, system, a first access request for accessing a target application managed by the IAM system;
rewriting, by the IAM system, the first access request to obtain a second access request comprising proxy domain name information generated based on domain name information of the IAM system and domain name information of the target application;
obtaining, by a proxy server, the second access request generated by the IAM system, and parsing the proxy domain name information of the second access request to determine the domain name information of the target application;
in case of determining that login authentication information is required to log in to the target application, obtaining, by the proxy server from the IAM system, login account information of a user with the target application based on the domain name information of the target application, and obtaining login authentication information input by the user; and
sending, by the proxy server, a login request to an application server corresponding to the target application based on the login account information and the login authentication information.

15. The device of claim 14, wherein rewriting, by the IAM system, the first access request to obtain a second access request comprises:
adding the domain name information of the IAM system into the first access request to obtain the second access request; or
combining, by the IAM system according to a predetermined format, the domain name information of the IAM system with the domain name information of the target application carried in the first access request to obtain the second access request.

16. The device of claim 14, wherein rewriting, by the IAM system, the first access request to obtain a second access request comprises:
rewriting, by the IAM system, the domain name information of the target application carried in the first access request, and encrypting the rewritten proxy domain name information to obtain the second access request carrying the encrypted proxy domain name information; and
the parsing the proxy domain name information of the second access request to determine the domain name information of the target application comprises:
decrypting the encrypted proxy domain name information in the second access request to obtain the decrypted proxy domain name information; and
extracting the domain name information of the target application from the decrypted proxy domain name information.

17. The device of claim 14, wherein the determining that login authentication information is required to log in to the target application comprises: determining that the login authentication information is required to log in to the target application based on registration management information stored in the IAM system for the target application; and
the method further comprises:
in case of determining that no login authentication information is required to log in to the target application, logging in to the target application by the IAM system to obtain an access credential; wherein the IAM system logs in to the target application based on the login account information in the registration management information;
accessing the target application based on the access credential.

18. The device of claim 14, wherein the login account information comprises a login username and a login password; and
obtaining from the IAM system login account information of a user with the target application comprises:
injecting, for a login webpage of the target application, a script for calling a login account; and
executing the script for calling the login account to obtain the login account information from the IAM system and fill in the login webpage with the login account information; the login webpage comprises a position region for filling in the login username and login password respectively.

19. The device of claim 18, wherein sending, by the proxy server, a login request to an application server corresponding to the target application based on the login account information and the login authentication information comprises:
in case that the login password filled in the login webpage is a predetermined virtual password, obtaining, from the IAM system, a real password corresponding to the login username based on the domain name information of the target application; and
sending, by the proxy server, the login request to the application server corresponding to the target application based on the real password and the login authentication information.

20. The device of claim 14, wherein after obtaining, by a proxy server, the second access request generated by the IAM system, and parsing the proxy domain name information of the second access request to determine the domain name information of the target application, the method further comprises:
searching for an access credential of the user for the target application from a center server based on the domain name information; and
in case of determining that login authentication information is required to log in to the target application, obtaining, by the proxy server from the IAM system, login account information of a user with the target application based on the domain name information of the target application, and obtaining login authentication information input by the user comprises:
in case of no access credential being searched and determining that the login authentication information is required to log in to the target application, obtaining, based on the determined domain name information of the target application, the login account information of the user from the IAM system, and obtaining the login authentication information input by the user.

21. The device of claim 20, wherein after the searching for an access credential of the user for the target application from a central server, the method further comprises:
in case of the access credential being searched, accessing the target application based on the access credential.

22. A non-transitory computer readable storage medium having a computer program stored thereon, that, when executed by a processor, performs acts comprising:
receiving, by an Identity and Access Management, IAM, system, a first access request for accessing a target application managed by the IAM system;
rewriting, by the IAM system, the first access request to obtain a second access request comprising proxy domain name information generated based on domain name information of the IAM system and domain name information of the target application;
obtaining, by a proxy server, the second access request generated by the IAM system, and parsing the proxy domain name information of the second access request to determine the domain name information of the target application;
in case of determining that login authentication information is required to log in to the target application, obtaining, by the proxy server from the IAM system, login account information of a user with the target application based on the domain name information of the target application, and obtaining login authentication information input by the user; and
sending, by the proxy server, a login request to an application server corresponding to the target application based on the login account information and the login authentication information.

23. The medium of claim 22, wherein rewriting, by the IAM system, the first access request to obtain a second access request comprises:
adding the domain name information of the IAM system into the first access request to obtain the second access request; or
combining, by the IAM system according to a predetermined format, the domain name information of the IAM system with the domain name information of the target application carried in the first access request to obtain the second access request.

24. The medium of claim 22, wherein rewriting, by the IAM system, the first access request to obtain a second access request comprises:
rewriting, by the IAM system, the domain name information of the target application carried in the first access request, and encrypting the rewritten proxy domain name information to obtain the second access request carrying the encrypted proxy domain name information; and
the parsing the proxy domain name information of the second access request to determine the domain name information of the target application comprises:
decrypting the encrypted proxy domain name information in the second access request to obtain the decrypted proxy domain name information; and
extracting the domain name information of the target application from the decrypted proxy domain name information.

25. The medium of claim 22, wherein the determining that login authentication information is required to log in to the target application comprises: determining that the login authentication information is required to log in to the target application based on registration management information stored in the IAM system for the target application; and
the method further comprises:
in case of determining that no login authentication information is required to log in to the target application, logging in to the target application by the IAM system to obtain an access credential; wherein the IAM system logs in to the target application based on the login account information in the registration management information;
accessing the target application based on the access credential.
